(19) United States
(12) Patent Application Publication
(10) Pub. No.: US 2017/0368641 A1
(43) Pub. Date: Dec. 28, 2017

(54) BRAZING ALLOY

(71) Applicant: UMICORE AG & CO. KG, Hanau-Wolfgang (DE)

(72) Inventors: Gunther WIEHL, Aschaffenburg (DE); Steven THIEROLF-DOEPP, Bruchköbel (DE); Inge FALLHEIER, Linsengericht (DE); Max SCHIMPFERMANN, Erlensee (DE); Daniel SCHNEE, Langenselbold (DE)

(21) Appl. No.: 15/541,138

(22) PCT Filed: Jan. 21, 2016
(86) PCT No.: PCT/EP2016/051187

§ 371 Date: Jun. 30, 2017

(30) Foreign Application Priority Data
Jan. 22, 2015 (DE) 10 2015 100 937.4

(51) Int. Cl. B23K 35/02; B23K 1/002; C22C 30/02; C22C 9/00; B23K 35/30; B23K 1/20; C22C 30/04; C22C 30/06; B23K 103/04; B23K 103/00; B23K 103/16

(52) U.S. Cl. CPC B23K 35/0222; C22C 30/04; B23K 1/002; C22C 30/02; C22C 9/00; C22C 30/06; B23K 35/302; B23K 1/203; B23K 2203/30; B23K 2203/166; B23K 2203/04

(57) ABSTRACT

The present invention relates to new brazing alloys containing copper, silver, zinc, manganese, and indium, and a method for their production and their use.

Brazing is an important technique for joining components, both in series production and for workpiece prototyping. Brazing is an economical procedure, which subjects the materials to low levels of mechanical stress, for joining metallic components by means of a metallic additive, the brazing solder. Optionally, fluxes and/or inert gases are often used. The melting temperature of the brazing solder is lower than the melting temperatures of the metallic components to be brazed. Both are wetted by the melted solder, without being melted themselves. Common brazing alloys for melting ranges between 600-800° C. are often Ag—Cu—Zn solders, and they are described in standards such as, for example, DIN EN ISO 17672 and AWS A5.8M/A5.8-2011 (Brazing Filler Metals) and U.S. Pat. No. 2,019,984.

Such alloys can be used for numerous applications, but do not always fulfill all requirements with regard to their susceptibility to corrosion, and due to a melting range that should be as low as possible for a given silver content.

Modified Ag—Cu—Zn brazing alloys having a higher silver content often also contain nickel (Ni) and manganese (Mn), and are known from DE 19725956. Such brazing alloys are often used in the tool industry. Nickel can be added to increase the strength of the brazed joints, as well as to improve wetting behavior on tool steels. However, this results in an increase in the melting range of the alloys. EP-A-1078711 discloses Ag—Cu—Zn brazing alloys that contain small amounts of gallium, indium, tin, or manganese. These alloys, however, often lack good mechanical properties like ductility and deformability, and exhibit increased melting temperatures given low silver contents, and thus the same disadvantages as materials with higher silver contents.

CN-A-102909489 discloses brazing solders that are suitable for brazing at above 850° C., but not at lower temperatures of 720° C. or 730° C., for example. The object was the provision of new brazing alloys that are easy to produce, [sic] may be processed at maximum brazing temperatures of approximately 710° C. to 730° C. in spite of a markedly reduced silver content relative to Ag449, in order not to negatively affect material properties in brazing of carbides and cermets with steel alloys, since the AC1 temperature of 723° C. from the iron-carbon phase diagram is thereby exceeded, which leads to the formation of austenite and subsequently to hard, brittle phases upon cooling, causing an unwanted hardening and embrittlement. Moreover, at these brazing temperatures, the brazing alloy should, at the brazed work piece, exhibit high shear strengths of at least 250 MPa, which are comparable to the shear strengths that may be achieved with the standard solder AG449, according to DIN EN ISO 17672.

The brazing alloys must, additionally, have good cold working capability at room temperature (for example, for cold rolling or wire drawing or wire rolling) and a sufficient ductility for brazed joints, and contain no cadmium, in order to be ecologically non-hazardous.

It is known that the silver content of Ag—Cu—X alloys plays a vital role in the liquidus temperature of the alloy, due to the eutectic behavior of the binary Ag—Cu system. Low-melting for a defined silver content means that a defined silver content (of 28%, for example) has significantly higher melting temperatures than an alloy with 49% silver, if no additional elements that decrease the melting point are added. The elements decreasing the melting point must in the process be combined in a skillful manner and be matched with elements increasing the melting point, so that the cold working capability and the strength of the joint connection are not negatively affected.

The object is achieved via the brazing alloy according to the claims.

One embodiment relates to a brazing alloy containing 25 to 33 wt % silver, 15 wt % to 25 wt % zinc, 6 wt % to 14 wt % manganese, 0.25 wt % to 4 wt % nickel, 0.5 wt % to 4 wt % indium, copper and unavoidable impurities to 100 wt %, and wherein the quantities of the components add up to 100 wt % in total;

or

a brazing alloy containing 26 to 30 wt % silver, 17 wt % to 23 wt % zinc, 8 wt % to 12 wt % manganese, 0.25 wt % to 2 wt % nickel, 1 wt % to 3 wt % indium, copper and unavoidable impurities to 100 wt %, and wherein the quantities of the components add up to 100 wt % in total;

or

a brazing alloy containing 27 to 29 wt % silver, 18 wt % to 22 wt % zinc, 9 wt % to 11 wt % manganese, 0.5 wt % to 1.5 wt % nickel, 1.5 wt % to 2.5 wt % indium, copper and unavoidable impurities to 100 wt %, and wherein the quantities of the components add up to 100 wt % in total.

These three embodiments are free of silicon, alkali and alkaline earth metals, phosphorus and cadmium, with the exception of unavoidable impurities.

The above embodiments may optionally contain 0 to 1.5 wt %—especially, 0.1 to 1.5 wt %—tin and/or gallium. These may be added for controlling the melting point—especially, its decrease—but lead to an embrittlement if the contents are too high.

The above embodiments may, optionally, moreover contain 0 to 1.50 to 1 wt % —especially, 0.1 to 1 wt %—cobalt—possibly together with the aforementioned addition of tin, gallium, or their combinations. Cobalt may be added in small quantities to control the melting point, but leads to a sharp increase in the liquidus temperature if too much is added, such that a careful dosing is applied.

The above embodiments may optionally contain 0 to 0.5 wt %—especially, 0.1 to 0.5 wt %—germanium—possibly together with the aforementioned addition of tin, gallium, cobalt, or their combinations. Similar to tin and gallium, germanium may be added for fine adjustment of the melting point, but likewise leads to embrittlement if quantities that are too large are added.

Due to its high toxicity, cadmium is to be avoided; due to its formation of intermetallic phases, silicon leads to a reduces strength; and alkali and alkaline earth metals (i.e., lithium, sodium, potassium, rubidium, cesium, francium, beryllium, magnesium, calcium, strontium, barium, and radium) are sensitive to oxidation. Phosphorus (P) may not be used, due to the formation of brittle intermetallic phases in brazed joints involving iron and iron-containing alloys.

Silicon, alkali and alkaline earth metals, phosphorus and cadmium may only be present in quantities of unavoidable impurities, just as with defined additional metals. The content of unavoidable impurities altogether may not be greater than 0.5 wt %, and, preferably, 0.3 wt %.

Aluminum may be present as an impurity in quantities of up to 0.001 wt %. Phosphorus, magnesium, or calcium, like the other alkali and alkaline earth metals listed above, may respectively be present as an impurity in quantities of up to 0.008 wt %. Cadmium, selenium, tellurium, tin, antimony, bismuth, and arsenic may be present as impurities in quantities of up to 0.01 wt % each. Lead may be present as an impurity in quantities of up to 0.025 wt %. Sulfur may be present as an impurity in quantities of up to 0.03 wt %. Silicon may also be present as an impurity in quantities of up to 0.05 wt %, and iron in quantities of up to 0.15 wt %. Impurities may be present in quantities of up to 0.5% by weight or 0.3% by weight or 0.15% by weight in total. “Free of cadmium and phosphorus” means a respective cadmium content of up to 0.01 wt % and phosphorus content of up to 0.008 wt %.

To preclude misunderstandings, it should be noted that the brazing alloy of the invention must contain copper. The copper content is normally 20 to 53.5 wt %.

Additional embodiments relate to the following brazing alloy which is free of silicon, alkali and alkaline earth metals, phosphorus and cadmium, with the exception of unavoidable impurities.

In a specific embodiment, the brazing alloy therefore contains

25 to 33 wt %, 26 to 30 wt %, or 27 to 29 wt % silver;

15 to 25 wt %, 17 to 23 wt %, or 18 to 22 wt % zinc;

6 to 14 wt %, 8 to 12 wt %, or 9 wt % to 11 wt % manganese;

0.25 to 4 wt % nickel, 0.25 to 2 wt %, or 0.5 to 1.5 wt % nickel;

0.5 to 4 wt % indium, 1 to 3 wt %, or 1.5 to 2.5 wt % indium;

20 to 53.25 wt %, 30 to 47.75 wt %, or 34 to 44 wt % copper;

0 to 1.5 wt % tin, gallium, or their combinations,

0 to 1 wt % cobalt,

0 to 0.5 wt % germanium,

and unavoidable impurities, wherein the quantities of the components add up to 100 wt % in total; or, in a further embodiment,

25 to 33 wt % silver, 15 to 25 wt % zinc, 6 wt % to 14 wt % manganese, 0.25 wt % to 4 wt % nickel, 0.5 wt % to 4 wt % indium, 20 to 53.25 wt % copper, 0 to 1.5 wt % tin, gallium, or their combinations, 0 to 1 wt % cobalt, 0 to 0.5 wt % germanium

and unavoidable impurities, wherein the quantities of the components add up to 100 wt % in total; or, in a further embodiment,

26 to 30 wt % silver, 17 to 23 wt % zinc, 8 wt % to 12 wt % manganese, 0.25 wt % to 2 wt % nickel, 1 wt % to 3 wt % indium, 30 to 47.75 wt % copper, 0 to 1.5 wt % tin, gallium, or their combinations, 0 to 1 wt % cobalt, 0 to 0.5 wt % germanium, and unavoidable impurities, wherein the quantities of the components add up to 100 wt % in total; or, in a further embodiment,

27 to 29 wt % silver, 18 to 22 wt % zinc, 9 wt % to 11 wt % manganese, 0.5 wt % to 1.5 wt % nickel, 1.5 wt % to 2.5 wt % indium, 34 to 44 wt % copper, 0 to 1.5 wt % tin, gallium, or their combinations, 0 to 1 wt % cobalt, 0 to 0.5 wt % germanium, and unavoidable impurities, and wherein the quantities of the components add up to 100 wt % in total.

A suitable example of an alloy consists of 39 wt % copper, 28 wt % silver, 20 wt % zinc, 10 wt % manganese, 2 wt % indium, and 1 wt % nickel.

The brazing alloy may be obtained by liquid phase alloying or mechanical alloying. One common way is by melting. The brazing alloy of the invention may be obtained simply by jointly melting the corresponding amounts of the alloying constituents. It is also possible to employ alloys as educts, e.g., to supplement an alloy consisting of silver, copper, and zinc with corresponding amounts of manganese and indium or an alloy thereof, and to melt this combination.

The melting can be done in inert gas, such as argon or nitrogen, or in air. Gas, electric, and induction furnaces, among others, are suitable devices for this purpose.

The molten alloy can be cast into a mold, atomized, or granulated, in order to obtain powders or granules. Atomized powder can, for example, be used for making brazing pastes. Both these powders and granules may be used for pressing and extrusion, as described further below. In this way, powders and granules may also be employed to produce stamped parts, wires, or rods. Melting can thus also be followed by production techniques such as ingot casting, continuous casting, melt spinning, alloy granulation, or atomization. Ingots and billets may also be used for extrusion molding or extrusion of the brazing alloy, and these may thus be brought into the shape of a wire or ribbon. The alloy may be produced and used as solid solder, and thus in the form of a rod, wire, wire coil, foil, plate, or stamped parts made from foil or plate, for example. Advantageous thicknesses for such foils or plates used are 0.1 to 0.5 mm; wires as well as rods may, generally, typically have diameters between 0.5 and 2.5 mm.

The geometry of such semi-finished products may be adjusted to customer demand via pressing, forging, wire drawing, hot or cold rolling, straightening, cutting, punching, or combinations thereof.

Continuous casting is an additional option for producing wires, ribbons, or rods. Moreover, it is possible to obtain the brazing alloy in the desired shape by rolling sheet metal, manufacturing shaped articles, such as rings, or punching stamped parts.

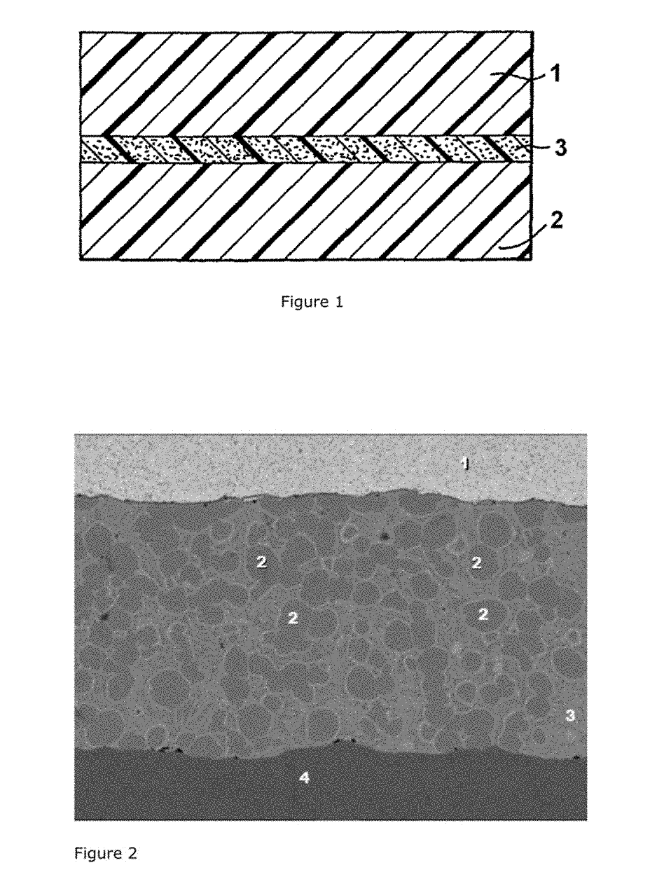

The brazing alloy may also be used for sandwich solder, which is a metal ribbon coated with brazing alloy on one or both sides. This is known in principle. It is also known how such sandwich solders may be produced—in general, by roll-bonding, composite casting—which is essentially the application of molten brazing alloy onto the metal ribbon with subsequent solidification—or also by roll-coating a solder paste or solder suspension onto the metal ribbon and subsequently heat treating it to vaporize and burn off solvents and organic constituents, with subsequent melting or sintering of the brazing powder. In FIG. 1, the structure of such a sandwich solder is depicted schematically. A metal ribbon 3 carries a first brazing alloy 1 and a second brazing alloy 2 on one side each of the metal ribbon 3. Both the first and the second brazing alloys may be brazing alloys according to the present invention. The first brazing alloy 1 and the second brazing alloy 2 may be identical or different. It may also be possible that one of the brazing alloys is a material according to the prior art, as long as at least one of the two brazing alloys is a brazing alloy in accordance with the present invention.

The metal ribbon may be made of any suitable metal, such as iron, steel, copper, nickel, and their alloys, but other metals and alloys may be suitable as well. The purity may be >99%—especially, >99.2%. The metal ribbon may have the form of a plate, but may also be a mesh or woven mesh or non-woven [sic] made of metal—especially, copper or nickel. Advantageous are a copper ribbon, Cu, or a ribbon made of copper alloy, e.g., a copper alloy that contains 0.1 to 10 wt % nickel, 0.1 to 10 wt % silicon, and a remainder of copper; or a copper alloy that contains 0.1 to 10 wt % nickel, 0.1 to 10 wt % iron, possibly up to 2 wt % manganese, and a remainder of copper; or a copper alloy that contains 1 to 15 wt % tin and 1 to 30 wt % nickel; or a copper alloy that contains 2 to 15 wt % manganese and 0.1 to 8 wt % silicon; or a copper alloy that contains 15 to 25 wt % manganese and 15 to 25 wt % nickel; wherein the components of these alloys always add up to 100 wt %.

The thickness of the metal ribbon can be expressed by the ratio of the thickness of the metal ribbon to the thickness of a single layer of the brazing. Typical ratios are 4:1, 1:1, 2:1, 1:0.85, and 1:0.28. Overall thicknesses of a sandwich solder amount to 0.1 mm to 1.5 mm or 0.2 mm to 1.2 mm, depending upon the technical requirements of the respective application.

The brazing alloy is especially suitable for brazing of carbides and cermets. Carbides are generally made of a hard material such as tungsten carbide, WC—often in powder or granular form—that has been infiltrated with a binder metal such as iron, nickel, cobalt, or alloys thereof.

In such applications, steel, hard metal, diamond, diamond segments, or polycrystalline diamonds are usually joined with the hard metal. A mixture of diamond and metallic binders such as bronze or cobalt alloys is designated as a diamond segment. Such brazed parts may be used to produce saw blades, milling tools, drill bits, or medical instruments.

The brazing alloy is likewise suitable for brazing of steel with steel.

The carbides may, especially, be brazed to substrate materials which, for example, consist of steel or stainless steel.

Suitable carbides, among others, are described in the standard DIN ISO 513 and, for example, H10, K5, K10, and P25.

Suitable steels, among others, are described in the standard DIN EN 10027-2 and, for example, 1.6582, 1.2003, 1.2235, and 1.8159.

In general, known fluxes—in the form of pastes, lacquers, powders, and coatings of the brazing alloys, which can be in the form of bars, rods, tapes, or wires—may be used for the brazing alloys of the invention. Suitable fluxes are, for example, FH10, FH11, FH12, FH20, and FH21, which are disclosed in the standard, DIN EN 1045.

Consequently, the invention also relates to shaped articles made from one of the brazing alloys of the invention in combination with fluxes. The brazing alloys may, in particular, be in the shape of wires, wire coils, or rods, and may be coated by a flux. In particular, rods or wires made of the brazing alloy of the invention may be coated with a flux selected from FH10, FH11, FH12, FH20, and FH21, as defined in standard DIN EN 1045.

The brazing with the brazing alloys of the invention may be carried out as in the following method for joining metal parts by brazing, with the steps of
providing a base material;
providing a part that is to be joined to the base material;
arranging the base material and the part in contact with one another in a way suitable for brazing;
arranging a brazing alloy according to the invention, or a combination thereof with a flux, in contact with the base material, the part, or both in a way suitable for brazing;
heat treating the arrangement thus obtained at a temperature sufficient to effect brazing, so as to obtain a joined part;
cooling the joined part.

The part thereby consists, in particular, of a carbide or a steel. The base material may, especially, be a steel.

The present application also relates to joined parts that are obtained according to this method.

The part to be brazed may consist of various materials that have already been described above, e.g., carbides and cermets—in particular, H10, K5, K10, P25 carbides. The base material may consist of various materials that have already been described above, e.g., steel, stainless steel, and tool steel—especially, steel alloys such as 1.6582, 1.2003, 1.2235, and 1.8159. Both the part and the base material may have various compositions, shapes, and dimensions, and may respectively be the same or different with respect to these parameters.

It is also possible to join a plurality of parts with the base material so that several parts, e.g., multiple carbide parts, may be joined with one base material, e.g., a saw blade, or vice versa.

These are arranged in contact with each other in such a way that they can be joined by brazing. A brazing alloy according to the invention—optionally, in combination with a flux—is then arranged on the part, the base material, or both. This may also occur prior to the arrangement of the part and base material on each other, e.g., by coating with a solder paste containing a brazing alloy according to the invention, and then arranging them, or via a continuous supply during the heat treatment, or the brazing alloy may be applied as a molded part, e.g., as a solder ring. The flux may be applied before or simultaneously with the brazing alloy. A solder rod having a coating or a core of a flux is one possibility for simultaneous application of the flux with the solder, but the part, the base material, or both may also be provided with a flux, e.g., by applying a liquid containing the flux.

The heat treatment may take place via torch brazing, via induction brazing, but also in a furnace (furnace brazing) or in another manner. Inert gas such as argon, nitrogen or hydrogen or mixtures thereof, or silane-doped atmospheres, may be used just as in brazing in air or in vacuum. The temperature of the heat treatment must be sufficient to melt the solder and allow it to flow and be wetted. The temperature must, however, lie below the melting temperatures of the parent material or the component. After the heat treatment step, the joined parts are allowed to cool.

Care is here especially to be taken that the brazing temperature be maintained, since, with brazing on steel, the transition temperature of the steel may not be reached, since its properties are thereby destroyed. Brazing temperatures in a range of 710° C. to 730° C. are well-suited for this.

A brazing method results from this, having the steps of
providing a base material;
providing a part that is to be joined to the base material;
arranging the base material and the part in contact with one another in a way suitable for brazing;
arranging a brazing alloy according to the invention, or a combination thereof with a flux, in contact with the base material, the part, or both in a way suitable for brazing;
heat treating the arrangement thus obtained to a temperature of 710° C. to 730° C. in order to effect brazing, and thus obtain a joined part;
cooling the joined part.

Upon brazing with the described alloys, round, often spherical, copper particles that form in the course of the melting process are created at the specified temperatures. These copper particles have a greater ductility than the surrounding material, since they contain a lower concentration of alloy elements, and therefore—as a disperse soft phase—have a positive effect upon the mechanical properties; the formation of a multi-phase material, so to speak, occurs, since these copper spheres produce a stress absorption by means of plastic deformation. The term “spherical copper particle” also designates other, similar forms of the copper particles that are also droplet-shaped, ovoid, or composed of multiple spheres, drops, or eggs. The three-dimensional, as described—rounded, copper particles that are contained in the structure of the brazing seam of the brazed article appear two-dimensionally, in a metallographic section, as nearly circular, copper-rich phases.

In order to achieve this effect, brazing must take place in a two-phase range, and thus at temperatures below the liquidus temperature. In the claimed alloys, this temperature range overlaps with the sought brazing temperature of 710° C. to approximately 730° C.

In FIG. 2, a scanning electron microscope exposure, with the aid of backscatter electrons, of a metallurgical section is displayed and shows the structure of an alloy consisting of 39 wt % copper, 28 wt % silver, 20 wt % zinc, 10 wt % manganese, 2 wt % indium, and 1 wt % nickel. 1 shows the carbide, 4 the steel, 3 is the continuous phase, and 2 is the disperse phase, and thus the round, often spherical, copper particle.

If the brazing temperature is above the liquidus temperature, and therefore above the sought brazing temperature, this structure does not form, which has the result that the mechanical properties of the brazing seam (i.e., the shear strength) vary, which generally involves a degradation in the mechanical properties. In this instance—thus, at a too-high brazing temperature above the liquidus temperature—dendrites form upon cooling at less than the customary cooling rate of a brazing application, such that a brazing at too high a temperature may be clearly identified by a metallurgical section, and possibly also at various locations of a braze seam. This information may be used for analysis of errors, defects, and quality control, but also for thermometer-less adjustment of the heat source or of the brazing device—all the more so as a local overheating of the articles to be brazed with one another may in fact occur, but cannot be detected with certainty via a check with a thermometer or thermoelement. The overheating (and, therefore, strength variations) in steel may thus be avoided by the user via structural examinations.

The present patent application therefore also relates to a method for monitoring the structure of brazed connections, having the steps of
providing a base material;
providing a part that is to be joined to the base material;
arranging the base material and the part in contact with one another in a way suitable for brazing;
arranging a brazing alloy according to the invention, or a combination thereof with a flux, in contact with the base material, the part, or both in a way suitable for brazing;
heat treating the arrangement thus obtained at a temperature sufficient to effect brazing, so as to obtain a joined part;
cooling the joined part;
production of at least one metallurgical section at least at one position of the braze seam;
examination of the structure via inspection of the metallurgical section;
if applicable, adaptation of the brazing conditions, in order to effect the occurrence of the desired structure.

The inspection of the structure may take place via light microscopy, scanning electron microscopy, or electron beam microscopy (abbreviated as: microprobes). A metallurgical section of the structure is required for this, which section may be obtained mechanically, via ion cutting and by means of electro-polishing or ionic polishing, as a longitudinal or cross-section.

### EXAMPLES

The alloys were obtained by melting the corresponding amounts of the alloy constituents in a crucible in an induction furnace and casting them in a graphite mold. These samples were used for the assessment of the alloys. The compositions in the table contain specifications in percentages by weight (wt %).

The cold working capability (Table: K) was assessed based upon repeated cold rolling. Several cold rolling passes with a thickness reduction of 1 mm per pass were performed without intermediate annealing, until a tearing of the sample occurred. The result is shown in the table.

The ratings have the following meanings:

+ good workability, ∘ limited workability, − poor workability.

The shear strength (Table: τ) of a braze joint was determined at room temperature after brazing of a sample body at 720° C., in that a manual device having a maximum load of 40 kN was used to determine the shear strength (Gerling Automation, Solder Strength Testing Device GLFP 800). A cuboid base material made of a 1.2210 (115CrV3) (DIN EN 10027-2) steel having dimensions of 30×8×8 mm was used as a sample body, and an uncoated carbide of type K10 (DIN ISO 513) having dimensions of 8×8×4 mm was used as a carbide, which was brazed to the base material at 720° C. with the solder to be tested.

The sample body was affixed horizontally in a matching mount above a shearing edge having a clearance of 0.4 mm between steel surface and braze seam. A uniform and planar application of force is ensured in this way.

The die of the testing device rests upon the carbide; its placement surface has dimensions of 8×4 mm.

The final arrangement allows a maximization of the ratio of the force in the y-direction and, simultaneously, reduced bending moment in the x-direction. The measured value corresponds to the maximum shear force and may be used to calculate the maximum shear strength.

The shear strength is obtained in MPa or N/mm² by dividing the measurement value (N) by 64 mm².

The ratings have the following meanings:

| | | Cu | Ag | Zn | Mn | In | Sn | Ni | Co | T | K |
|---|---|---|---|---|---|---|---|---|---|---|---|
| | Examples | | | | | | | | | | |
| In | 1 | 39.00 | 28 | 20 | 10 | 2.00 | | 1.00 | | + | + |
| | 2 | 39.00 | 28 | 18 | 12 | 2.00 | | 1.00 | | + | + |
| | 3 | 37.00 | 30 | 20 | 10 | 2.00 | | 1.00 | | + | + |
| | 4 | 39.00 | 26 | 22 | 10 | 2.00 | | 1.00 | | + | + |
| | 5 | 39.00 | 30 | 20 | 8 | 2.00 | | 1.00 | | + | + |
| | 6 | 38.75 | 28 | 20 | 10 | 2.25 | | 1.00 | | + | + |
| | 7 | 39.25 | 28 | 20 | 10 | 1.75 | | 1.00 | | + | + |
| | 8 | 38.00 | 28 | 20 | 10 | 2.00 | | 2.00 | | + | + |
| | 9 | 35.00 | 30 | 20 | 10 | 2.00 | | 3.00 | | + | + |
| | 10 | 39.25 | 28 | 20 | 10 | 2.00 | | 0.75 | | + | + |
| | 11 | 38.50 | 28 | 20 | 10 | 2.00 | 0.50 | 1.00 | | + | + |
| | Comparative examples | | | | | | | | | | |
| Ag449 | 30 | 16.00 | 49 | 23 | 8 | | | 4.50 | | + | + |
| In | 31 | 35.00 | 28 | 20 | 10 | 6.00 | | 1.00 | | ◯ | − |
| | 32 | 41.00 | 28 | 20 | 10 | | | 1.00 | | ◯ | + |
| | 33 | 36.00 | 28 | 20 | 10 | | | 6.00 | | − | + |
| | 34 | 31.00 | 28 | 20 | 10 | 2.00 | | 9.00 | | − | + |
| | 35 | 49.00 | 28 | 10 | 10 | 2.00 | | 1.00 | | − | + |
| | 36 | 29.00 | 28 | 30 | 10 | 2.00 | | 1.00 | | + | − |
| | 37 | 46.00 | 28 | 20 | 3 | 2.00 | | 1.00 | | − | + |
| | 38 | 29.00 | 28 | 20 | 20 | 2.00 | | 1.00 | | ◯ | − |
| | 39 | 40.00 | 28 | 20 | 10 | 2.00 | | | | ◯ | + |
| | 40 | 52.00 | 15 | 20 | 10 | 2.00 | | 1.00 | | − | + |

+ >=250 MPa;
◯ 150 to <250 MPa;
− <150 MPa.

1. A brazing alloy consisting of 25 to 33 wt % silver, 15 to 25 wt % zinc, 6 wt % to 14 wt % manganese, 0.25 wt % to 4 wt % nickel, 0.5 wt % to 4 wt % indium, 0 to 1.5 wt % tin and/or gallium, 0 to 1 wt % cobalt, 0 to 0.5 wt % germanium, 20 to 53.5 wt % copper, and—as unavoidable contaminants—aluminum in quantities of up to 0.001 wt %, phosphorus, magnesium, or calcium, as well as other alkali and alkaline earth metals, in respective quantities of up to 0.008 wt %, cadmium, selenium, tellurium, tin, antimony, bismuth, and arsenic in respective quantities of up to 0.01 wt %, lead up to 0.025 wt %, sulfur up to 0.03 wt %, silicon up to 0.05 wt %, and iron in quantities of up to 0.15 wt %, wherein the quantity amounts to up to 0.5 wt %, and wherein the quantities of the components add up to 100 wt % in total.

2. Brazing alloy according to claim 1, containing 26 to 30 wt % silver, 17 to 23 wt % zinc, 8 wt % to 12 wt % manganese, 0.25 wt % to 2 wt % nickel, and 1 wt % to 3 wt % indium.

3. Brazing alloy according to claim 1, containing 27 to 29 wt % silver, 18 to 22 wt % zinc, 9 wt % to 11 wt % manganese, 0.5 wt % to 1.5 wt % nickel, and 1.5 wt % to 2.5 wt % indium.

4. Brazing alloy according to claim 1, containing 0.1 to 1.5 wt % tin and/or gallium, and/or 0.1 to 1 wt % cobalt and/or 0.1 to 0.5 wt % germanium.

5. A brazing combination comprising a brazing alloy according to claim 1 and a flux.

6. A method for joining metal components comprising the steps of
providing a base material;
providing a part that is to be joined to the base material;
arranging the base material and the part in contact with one another in a way suitable for brazing;
arranging the brazing alloy according to claim 1, in contact with the base material, the part, or both, in a way suitable for brazing;
heat treating the arrangement thus obtained at a temperature sufficient to effect brazing, so as to obtain a joined part;
cooling the joined part.

7. Method according to claim 6, wherein the temperature sufficient to produce the brazing is 710° C. to 730° C.

8. Method according to claim 6, wherein the base material or the part is a steel alloy.

9. Method according to claim 6, wherein the base material or the part is a carbide or a cermet.

10. A brazed article produced by the method according to claim 6.

11. Brazed article according to claim 10, wherein the brazed article has a braze seam of the brazed article which shows copper-rich phases of nearly circular appearance in a metallographic section.

12. A method for joining metal components comprising the steps of
providing a base material;
providing a part which is to be connected to the base material, wherein the base material or the part is a steel alloy;
arranging the base material and the part in contact with one another in a way suitable for brazing;
arranging the brazing alloy according to claim 1 in contact with the base material, the part, or both, in a way suitable for brazing;
heat treating the arrangement thus obtained at a temperature of 710° C. to 730° C., in order to obtain a joined part;
cooling the joined part.

13. A method for controlling the structure of braze joints, having the steps of
providing a parent material;
providing a part that is to be connected to the parent material;
arranging the parent material and the part in contact with one another in a way suitable for brazing;
arranging the brazing alloy according to claim 1 in contact with the base material, the part, or both, in a way suitable for brazing;
heat treating the arrangement thus obtained at a temperature sufficient to effect brazing, so as to obtain a joined part;
cooling the joined part;
production of at least one metallurgical section at least at one position of the braze seam;
examination of the structure via inspection of the metallurgical section;
if applicable, adaptation of the brazing conditions to a temperature of 710° C. to 730° C., such that the structure of the braze seam of the brazed article shows copper-rich phases of nearly circular appearance in a metallographic section.
